(19) United States
(12) Patent Application Publication
(10) Pub. No.: US 2025/0042638 A1
(43) Pub. Date: Feb. 6, 2025

(54) Securing Sticker for Beverage Cup Lid

(71) Applicant: Nina Marie Sivaslian, Denver, CO (US)

(72) Inventor: Nina Marie Sivaslian, Denver, CO (US)

(21) Appl. No.: 18/787,438

(22) Filed: Jul. 29, 2024

Related U.S. Application Data
(60) Provisional application No. 63/530,800, filed on Aug. 4, 2023.

(51) Int. Cl. B65D 77/20; B65B 3/04; B65B 7/28; C09J 7/24; C09J 7/38

(52) U.S. Cl. CPC B65D 77/2024; B65B 3/04; B65B 7/2864; C09J 7/245; C09J 7/38; C09J 2301/302; C09J 2427/006

(57) ABSTRACT

A sticker for securing a lid to a beverage cup is described. The sticker, which is comprised a thin flexible sheet material, includes a body that is placed over the top of a lid and a plurality of appendages (or legs) that wrap over the edge of the lid and lip of the cup to be adhesively secured to the cylindrical side of the associated cup.

### RELATED REFERENCES

This application claims priority to and incorporates fully by reference Provisional Patent Application 63/530,800 filed on Aug. 3, 2023 having the same title as the present application.

### BACKGROUND

In recent years, the use of prepared food delivery services has skyrocketed such as Doordash, Uber Eats, and Grubhub. It is now common place for consumers, instead of going to a restaurant to pick up food they have ordered or even eating at the restaurant, to use a third-party delivery service to pick up the order and deliver it to their doorsteps.

Beverages have always presented a problem for food delivery and transport in general. Disposable cups containing a beverage must usually be kept upright to prevent a spill. Further, cups often include snap on lids that prevent inadvertent spillage caused by sloshing and the like. Unfortunately, these lids, which are typically frictionally secured to the lip of a cup, can pop off of the cup when knocked or jostled potentially causing a significant spill. Simply, traditional disposable cups and lids are not designed for the rougher handling associated with the delivery services.

### BRIEF DESCRIPTION OF THE DRAWINGS

FIG. 1 is a top view of a beverage cup lid sticker according to an embodiment of the present invention.

FIG. 2 is a cross-sectional view along Line A-A of FIG. 1 according to the embodiment of the present invention.

FIG. 3 is a perspective view of a beverage cup lid sticker secured to a beverage cup and lid according to an embodiment of the present invention.

FIG. 4 is a perspective view of the combination of FIG. 3 showing the cup containing a beverage turned upside down according to an embodiment of the present invention.

FIG. 5 is a perspective view of a roll of beverage cup stickers according to an embodiment of the present invention.

FIG. 6 is a top view of a thermoplastic beverage lid sheet prior to forming and securement to the top of a cup according to an embodiment of the present invention.

FIG. 7 is a perspective view of a formed thermoplastic beverage lid secured to a beverage cup and lid according to an embodiment of the present invention.

### DESCRIPTION

### Overview

Embodiments of the present invention comprise a sticker for securing a lid to a beverage cup. The sticker is comprised of a thin flexible sheet material, such as vinyl, and includes a body that is placed over the top of a lid and a plurality of appendages (or legs) that extend over the edge of the lid and lip of the cup to be adhesively secured to the side or sides of an associated cup. At least portions of the bottom sides of the appendages are adhesively tacky to adhere to the side(s) of the cup. In some variations, the sheet material is self-adhesive, and in other variations, a pressure sensitive adhesive layer is provided. Advantageously, once the sticker is applied to a lid of a beverage cup securing the lid to the cup, the cup can be tipped over and otherwise jostled with the reduced risk that the lid will become dislodged from the cup and cause a significant spill of a beverage contained therein.

In some embodiments a plurality of stickers are provided on a roll of release paper so that they can be easily removed and applied to beverages by restaurant workers and/or food delivery drivers.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive, rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, upper, lower, vertical, horizontal, back, front, lateral, outwardly, and upwardly are relative to each other and are dependent on the specific orientation of an applicable element or article, and are used accordingly to aid in the description of the various embodiments and are not necessarily intended to be construed as limiting.

Unless otherwise indicated or dictated by context, the terms “approximately” and “about” mean +−20%. Unless otherwise indicated or dictated by context, the term “substantially” means +−10%. The term “generally” means for the most part.

### An Embodiment of a Sticker for a Beverage Cup Lid

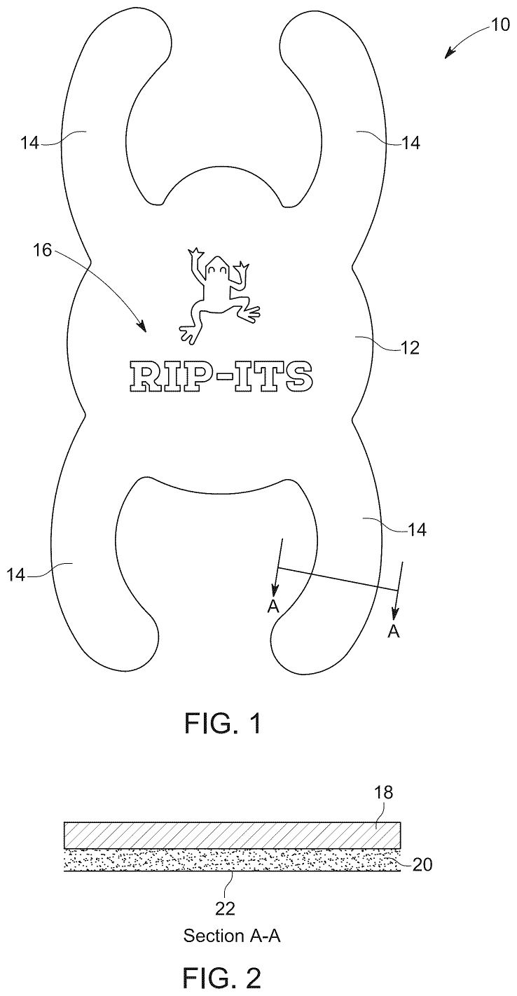

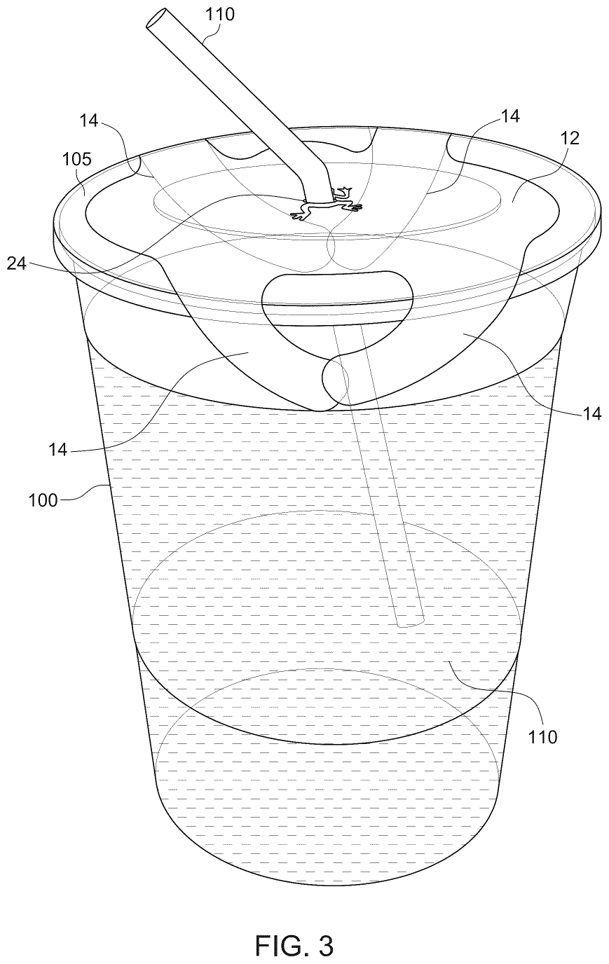

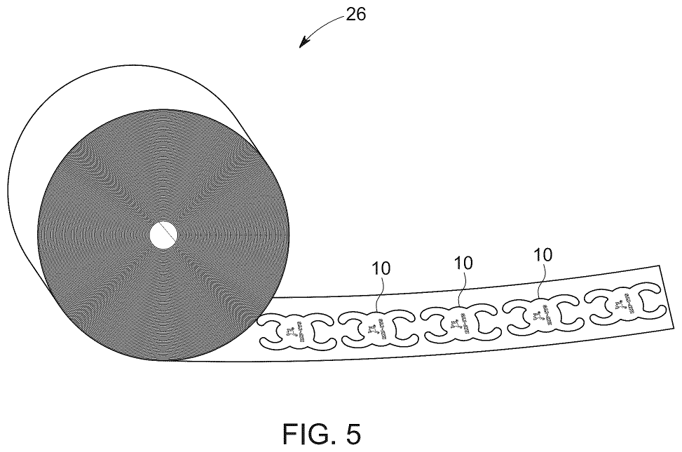

FIGS. 1 & 2 show different views of an embodiment of the sticker 10. FIGS. 3 & 4 show an embodiment of the sticker applied to a cup 100 and associated lid 105. The sticker comprises a thin sheet material substrate 18 that has a pressure sensitive adhesive 20 applied to a portion or all of a back side thereof. The front side can be plain or adorned with indicia 16, such as a trademark and contact information for an associated food delivery service. Additionally, a release paper or sheet 22 is typically provided that covers the adhesive and is removed from the sticker by a user prior to application. A plurality of stickers can be provided in a roll 26 (as shown in FIG. 5) wherein the release paper forms a roll on which the stickers are arranged, such as linearly.

The flexible sheet material 18 comprising the sticker's substrate can vary between embodiments, but in at least one variation the substrate comprises a thin vinyl sheet material about 1-3 mils thick. In other embodiments, the sheet material can comprise coated or uncoated paper, woven and unwoven fabrics, and other polymeric materials. The sheet material is typically at least partially drape-able and conformable to a lid and cup when in use.

As shown, the sheet material 14 is cut into a form comprising a body 12 and the plurality of appendages 14. The body is sized to be received over and cover a substantial portion of a lid 105. Typically, the body, which is generally round, does not extend beyond or much beyond the edges of a lid in use. The plurality of appendages 14, which are typically are at least ⅓ and more preferably at least ½ the diameter of the body in length, extend from the edge of the body and are configured to wrap over the edge of the lid and be adhered to the side(s) of the cup 100 below the cup's lip more effectively securing the lid in place to minimize the risk of unintended spills during transport.

Additionally, the appendages 14 can be configured to be easily ripped or torn proximate their intersections with the sticker's body 12 to facilitate the lid's removal from the cup 100 as desired. In some variations, a notch maybe provided proximate the appendage/body intersections. In other variations, the sticker may be perforated proximate the intersections.

Various types of pressure sensitive adhesive layers 20 can be utilized to coat all or part of the bottom surface of the sheet material substrate 18, but the adhesive typically comprises a material providing a low to moderate level of adhesiveness to facilitate removal from the cup and lid but sufficient to prevent inadvertent release therefrom. Typically, a natural or synthetic rubber adhesive is used, although adhesives of other chemistries can also be used as well. The adhesive can be of the type that exhibits tackiness even when wet or when being applied to a wet surface, such that drops of condensation or beverage runoff present on the side of the cup 100 does not hinder usage.

In all variations having an adhesive layer, the adhesive layer 20 covers substantial portions of the appendages 14 as they adhere to the side(s) of the beverage cup 100 to help hold the lid 105 in place. In some variations, the entire bottom surface of both the appendages and the body is covered with adhesive to more securely join the cup and lid.

In yet other variations of the sticker 10, the sheet material 18 may have a self-adhesive bottom surface, such as self-adhesive vinyl, wherein the surface texture of the backside of the sheet has adhesive properties allowing it to stick and cling to the cup and the lid. In this variation, no additional adhesive need be added to the substrate sheet material.

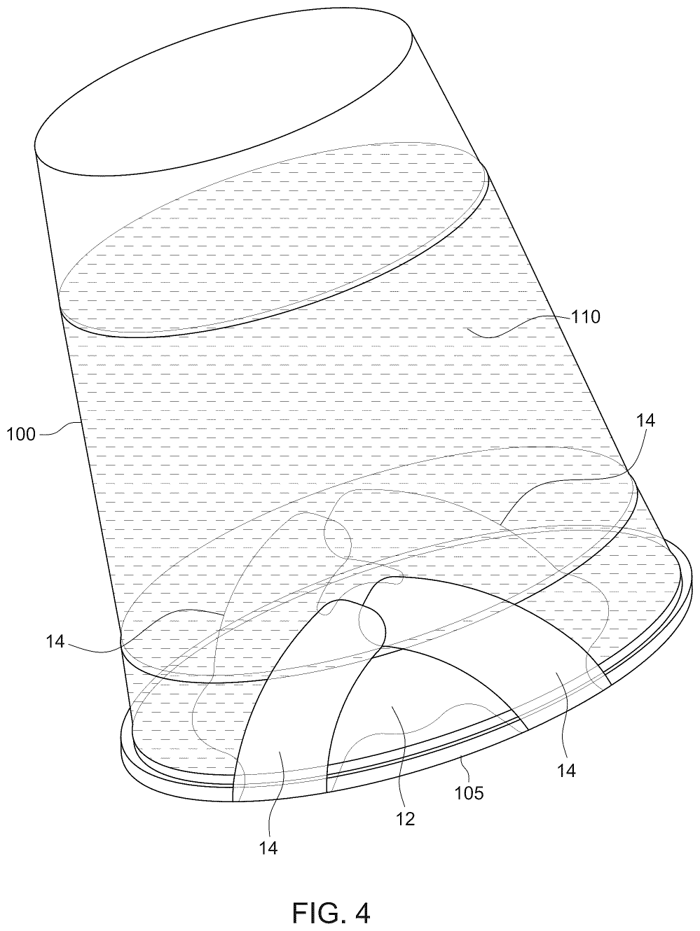

As shown in FIG. 4, the adhesive 20 and associated sticker 10 are typically strong enough to prevent the lid 105 from separating from the cup 100 even when the full weight of the beverage 110 contained therein is pressing on the lid when turned upside down.

Wherein a pressure sensitive adhesive 20 is used, release paper 22 is provided to cover the adhesive prior to use. The release paper both protects the adhesive layer as well as provide additional physical integrity to the thin sticker allowing it to be handled without having the thin sheet material fold over on itself. With reference to FIG. 5, the release paper can comprise a roll 26 with a plurality of stickers 10 provided along the role making it particularly convenient and easy for a user, such as a restaurant worker, to peel off a sticker for use.

In the illustrated embodiment shown in FIGS. 1-4, the sticker 10 includes a pair of generally upwardly extending appendages 14 and a pair of two generally downwardly extending appendages 14 having the general appearance of a stylized frog. It is appreciated, however, that as few as three appendages or more than four appendages can be used in variations. Further, the appendages can be spaced about the body 12 in any suitable manned. Also, as shown the legs are generally curved, which permits the ends to overlap slightly when the sticker is affixed to a cup 100 (see FIG. 3) for more secure attachment, and to make it easier pull the appendages free of the sides of the cup. However, the shape of the legs can vary substantially dictated in some degree by the number and distribution of the legs around the sticker's body.

As indicated above, the sticker's substrate 18 is typically thin and capable of being intentionally torn or punctured by a user as desired. FIG. 3 shows a straw 110 that has been inserted through the body of the sticker and through the provided port in the underlying lid 105. Advantageously, the neither the sticker nor the lid need be removed from the beverage cup 100 and lid to permit a user to consume the beverage.

The sticker can be produced by any suitable means but typically the sheet material is provided in sheet or roll form with an adhesive previously deposited on the back side (as necessary) and a release backing sheet covering the back side. The sheet or roll is typically fed through a die cutter that stamps and cuts the desired shape into the sheet material. Further, the excess sheet material surrounding the die cut sticker may be removed from sheet or roll and discarded or saved for recycling. In another optional operation that occurs before or after die cutting, the surface of the sticker maybe printed with suitable indicia 16, such as the name of restaurant or delivery service.

In use, a sticker is removed from the backing release sheet or roll and placed over the beverage cup lid that has been previously secured to the top of the associated beverage cup. The appendages are pressed against the side of the cup to secure them in place. The sticker can be placed on a filled beverage cup and lid at the time the beverage is dispensed by the restaurant worker so that the recipient of the beverage can be assured the beverage has not been tampered with if the sticker remains secure and intact at the time of delivery.

### Embodiments of a Thermo-Bonded Beverage Cup Lid

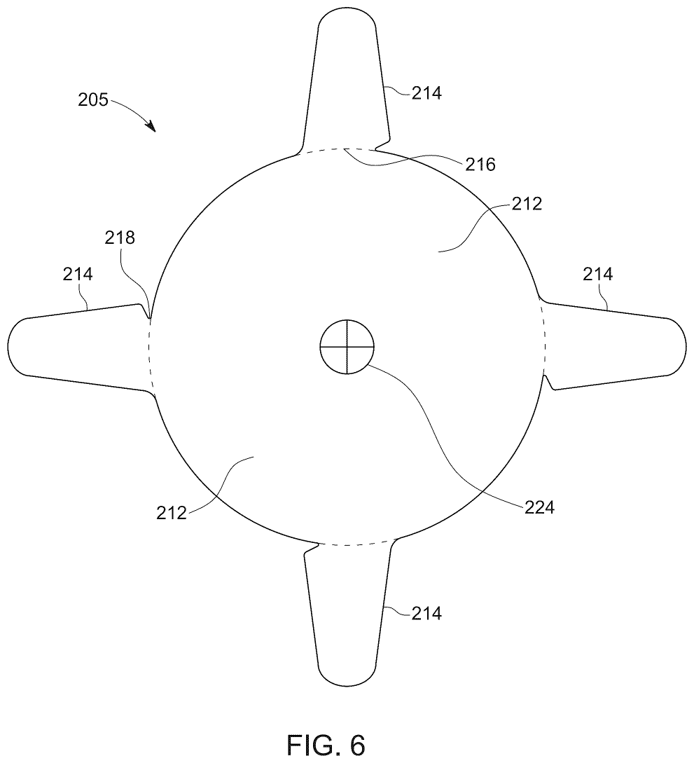

FIGS. 6 & 7 is an embodiment of a beverage cup lid 200 the is provided in sheet form similar to the sticker of FIG. 1 but with a larger body the overhangs the lip of the associated cup 200. The sheet material comprising the lid is typically thicker than the sheet material used in the sticker described above and is comprised of a thermoplastic polymeric material that can be formed and at least partially melted with heat. The thermoplastic material is a type compatible with the polymeric material of the associated cup having the same or preferably a lower melting point than the cup and being able to adhesively adhere to the cup when heated to a sufficient temperature.

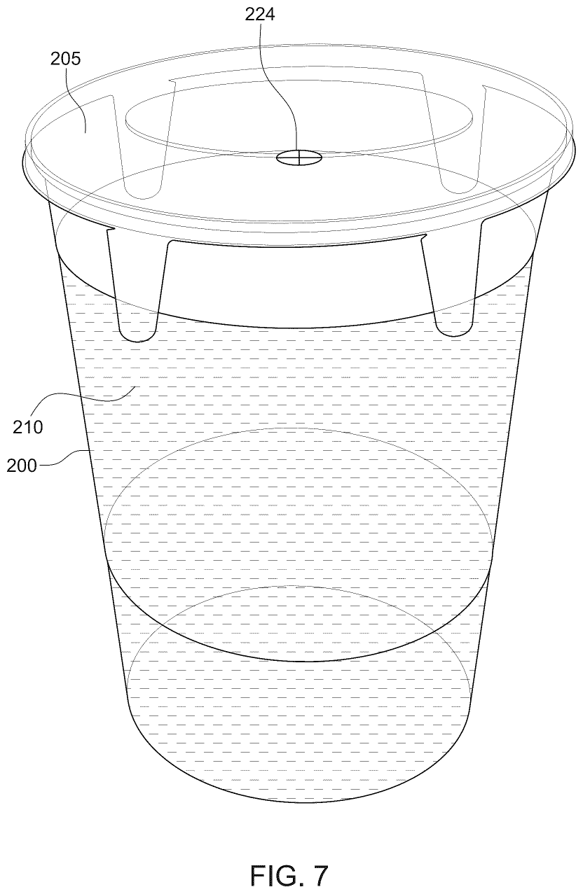

As shown in FIG. 7, the lid 205 is substantially flat prior to application to a beverage cup 200, It comprises a generally circular body 212 configured to overhang the lip of the associated cup 210. Three or more appendages 214 extend from and are spaced about the perimeter of the body. The intersection of each appendage with the perimeter can include perforations 216 and/or a notch 218, which would facilitate the tearing of the body from the appendages to access the beverage contained in the cup. The lid may also include a cutout or slits 224 through which a straw may be inserted.

In use, the unformed flat lid 205 is placed over and centered on the top of the cup 200 after it is filled with a beverage 210. Next, the head of a thermoforming machine is placed over the lid and the top of the cup. When activated, the thermoforming sheet heats the perimeter of the lid's body 212 and the appendages 214 to at or near its melting point and conforms the lid over the lip of the cup. The appendages are brought into contact with the side(s) of the cup and while in the heated state pressed against the side(s) of the cup adhering the appendages to the cup. To access the beverage contained therein, a user can insert a straw through the provided cutout or slits, or the user can tear the body away from the secured appendages to uncover the open top of the cup.

### Embodiments of an Adhesive Beverage Cup Lid

An adhesive embodiment of a beverage cup lid similar to the thermoplastic illustrated in FIG. 6 is also known. The adhesive cup lid is wider in diameter than the lip of the beverage cup on which it is to be received such that the edges thereof can be draped over and around the lip and adhesively secured to the side(s) of the cup proximate the lip. Unlike the thermoplastic lid 200, this lid is typically comprised of a thin material similar to that of the lid sticker 10 so that it is adequately conformable by a user without the application of heat or the use of an additional machine or device.

As can be appreciated, an adhesive similar to the adhesive 20 used with the lid sticker 10 is selectively applied to the bottom of the adhesive beverage cup lid. The adhesive layer is typically applied to the bottom side in a ring around the circumference of the lid and to the appendages, or stated another way, the adhesive is applied to areas on the lid's bottom that are to come in contact with the side(s) of the associated beverage cup when the lid is secured thereto. As can be appreciated, the adhesive is not typically applied to areas of the lid that will potentially come into contact with the beverage contained within the cup.

In one use of the adhesive lid, it can be carried by party goers to apply to a drink they are consuming to minimize the risk that the drink can be spiked thereafter. To access the beverage, a straw can typically be inserted through the thin substrate of the lid.

### Variations and Other Embodiments

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A beverage cup lid sticker comprising:
a thin flexible sheet material with top and bottom surfaces having a generally circular body with three or more appendages spaced around a circumference of the body, each appendage having a length equal to at least ⅓ the diameter of the generally circular body;
wherein at least substantial portions of the appendages on the bottom side are adhesively tacky.

2. The sticker of claim 1, wherein the bottom surface includes a pressure sensitive adhesive layer applied to at least substantial portions of the appendages.

3. The sticker of claim 1, wherein the bottom surface of the sheet material in at least a substantial portion of the appendages is self-adhesive.

4. The sticker of claim 1, wherein the sheet material comprises vinyl.

5. The sticker of claim 4, wherein the vinyl is 1-3 mils thick.

6. The sticker of claim 2, wherein the pressure sensitive layer covers essentially the entire bottom surface.

7. The sticker of claim 1 further including indicia printed on the top surface.

8. In combination, a plurality of stickers of claim 1 distributed on a roll of release paper.

9. In combination, a beverage cup, a beverage contained in the cup, a lid secured to a mouth of the cup, and the sticker of claim 1, wherein the body is received over a top of the lid and each of the three or more appendages are adhesively secured to upwardly-extending sides of the beverage cup.

10. The combination of claim 9, further including a straw, the straw being received through the body and the lid and into the beverage.

11. A method of filling a beverage cup with a beverage for transport, the method comprising:
providing a beverage cup, and a lid configured to fit over a rim of the beverage cup;
providing a beverage cup lid sticker, the lid sticker comprising a thin flexible sheet material with top and bottom surfaces having a generally circular body with three or more appendages spaced around a circumference of the body, each appendage having a length equal to at least ½ the diameter of the generally circular body wherein at least substantial portions of the appendages on the bottom side are adhesively tacky;
at least partially filling the beverage cup with a beverage;
securing the lid to the rim of the beverage cup;
placing the generally circular body over the lid with the three or more appendages hanging downwardly from a circumferential lip of the lid; and
pressing the three or more appendages against a side or sides of the beverage cup to adhesively secure the appendages to the side or sides.

12. The method of claim 11, further including removing the beverage cup lid sticker from a backing paper before said placing the generally circular body over the lid.

13. The method of claim 11, further including puncturing the generally circular body with a straw above a straw opening in the lid, and inserting the straw into the beverage.

14. A beverage cup lid sticker comprising:
a thin flexible sheet material with top and bottom surfaces having a generally circular body with two pairs of appendages extending from a circumference of the body, each appendage of the two pairs having a length equal to at least ⅓ the diameter of the generally circular body and having a bottom side substantially covered with a pressure sensitive adhesive layer, wherein the first pair is located proximate a top the circumference and the second pair is located proximate a bottom of the circumference with the appendages of each pair being curved in a direction of the other appendage of the pair.

15. The sticker of claim 14 wherein the sticker resembles an outline of a frog.

16. The sticker of claim 1, wherein the sheet material comprises vinyl.

17. In combination, a plurality of stickers of claim 1 distributed on a roll of release paper.

18. In combination, a beverage cup, a beverage contained in the cup, a lid secured to a mouth of the cup, and the sticker of claim 1, wherein the body is adhesively secured to a top of the lid and each appendage of the two pairs of the appendages being adhesively secured to upwardly-extending sides of the beverage cup.

19. The combination of claim 18, wherein one appendage of each pair of appendages overlaps the other appendage of each pair proximate ends of the appendages.

20. The combination of claim 19, further including a straw, the straw being received through the body and the lid and into the beverage.
